(19) United States
(12) Patent Application Publication
(10) Pub. No.: US 2025/0089093 A1
(43) Pub. Date: Mar. 13, 2025

(54) NON-COHERENT JOINT TRANSMISSION (NCJT) SCHEME IN A WIRELESS NETWORK

(71) Applicant: NEWRACOM, Inc., Irvine, CA (US)

(72) Inventors: Si-Chan NOH, Seoul (KR); Joonsoo LEE, Seoul (KR); Yeon-Geun LIM, Seoul (KR)

(73) Assignee: NEWRACOM, Inc., Irvine, CA (US)

(21) Appl. No.: 18/826,826

(22) Filed: Sep. 6, 2024

Related U.S. Application Data
(60) Provisional application No. 63/595,221, filed on Nov. 1, 2023.
(60) Provisional application No. 63/581,821, filed on Sep. 11, 2023.

(51) Int. Cl. H04W 74/0816; H04L 1/00; H04L 5/00

(52) U.S. Cl. CPC H04W 74/0816; H04L 1/0003; H04L 5/0053

(57) ABSTRACT

An embodiment is method performed by a sharing access point (AP) to initiate a non-coherent joint transmission (NCJT). The method includes transmitting a backhaul data PPDU that includes data intended for a station (STA) to a shared AP via a backhaul link and transmitting a NCJT sounding trigger frame to the shared AP via the backhaul link to cause the shared AP to participate in the NCJT, wherein the NCJT involves a plurality of APs, including the shared AP, transmitting NCJT PPDUs that include the data intended for the STA to the STA at different times.

### CROSS-REFERENCE TO RELATED APPLICATION

This application claims the benefit of U.S. Provisional Application No. 63/595,221,titled, “Apparatus and methods for Non-Coherent Joint Transmission (NCJT) beyond IEEE 802.11be networks,” filed Nov. 1, 2023; and U.S. Provisional Application No. 63/581,821, titled, “Non-Coherent Joint Transmission (NCJT) beyond IEEE 802.11be networks,” filed Sep. 11, 2023, which are hereby incorporated by reference.

### TECHNICAL FIELD

The present disclosure generally relates to wireless communications, and more specifically, relates to a non-coherent joint transmission (NCJT) scheme in a wireless network.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11 ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

The scope of next generation wireless networks (e.g., wireless networks that are to implement a beyond IEEE 802.11be or IEEE 802.11bn wireless networking standard) may include multi-AP coordination schemes such as coordinated time-division multiple access (C-TDMA), coordinated orthogonal frequency division multiple access (C-OFDMA), coordinated-beamforming (C-BF), coordinated-nulling, and/or joint transmission (JTX) to improve spectral efficiency in dense network scenarios. With existing wireless networks (e.g., wireless networks implementing existing IEEE 802.11 wireless networking standards), when access points (APs) participate in a joint transmission, tight synchronization is needed between the APs. However, tight synchronization between APs may not always be possible.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a frame exchange sequence of a non-coherent joint transmission (NCJT) scheme in which a sharing AP participates in the NCJT, according to some embodiments.

FIG. 11 is a diagram showing a frame exchange sequence of a NCJT scheme in which a sharing AP does not participate in the NCJT, according to some embodiments.

FIG. 12 is a flowchart of a method for initiating a NCJT, according to some embodiments.

FIG. 13 is a flowchart of a method for participating in a NCJT, according to some embodiments.

FIG. 14 is a flowchart of another method for initiating a NCJT, according to some embodiments.

FIG. 15 is a flowchart of another method for participating in a NCJT, according to some embodiments.

### DETAILED DESCRIPTION

The present disclosure generally relates to wireless communications, and more specifically, relates to a non-coherent joint transmission (NCJT) scheme in a wireless network.

As mentioned above, with existing wireless networks (e.g., wireless networks implementing existing Institute of Electrical and Electronics Engineers (IEEE) 802.11 wireless networking standards), when access points (APs) participate in a joint transmission, tight synchronization is needed between the APs. However, tight synchronization between APs may not always be possible.

To address this problem, a NCJT scheme is described herein that allows multiple APs to transmit the same data to a station (STA) that is within the coverage areas of the APs without requiring tight synchronization between the APs. The NCJT scheme may allow the STA to more reliably decode the data transmitted by the APs (e.g., be able to decode the data even under unfavorable network conditions (e.g., in the presence of interference and noise)). Joint transmission schemes require tight synchronization between APs, which may not always be possible. Advantageously, since the NCJT scheme described herein does not require tight synchronization between APs, it can be used even in situations where tight synchronization between APs is not possible. Thus, in situations where tight synchronization between APs is not possible, the NCJT scheme described herein may be more effective than a joint transmission scheme.

A NCJT scheme may involve a sharing AP and one or more shared APs. A sharing AP is an AP that initiates the NCJT. A shared AP is a non-sharing AP that participates in the NCJT. The sharing AP may or may not participate in the NCJT.

According to some embodiments (embodiments where the sharing AP participates in the NCJT), a sharing AP transmits a backhaul data physical layer protocol data unit (PPDU) that includes data intended for a STA to a shared AP via a backhaul link. The sharing AP may then transmit a NCJT sounding trigger frame to the shared AP via the backhaul link to cause the shared AP to participate in the NCJT. Both the sharing AP and the shared AP may participate in the NCJT by transmitting NCJT PPDUs that include the data intended for the STA to the STA, but at different times. For example, the sharing AP may transmit a NCJT PPDU that includes data intended for the STA to the STA after transmitting the NCJT sounding trigger frame to the shared AP. Also, responsive to receiving the NCJT sounding trigger frame from the sharing AP, the shared AP may transmit a NCJT PPDU that includes data intended for the STA to the STA after the sharing AP transmits its NCJT PPDU to the STA. Responsive to receiving the NCJT PPDUs from the sharing AP and the shared AP (at different times), the STA may transmit a NCJT acknowledgment (ACK) frame to the sharing AP (and also to the shared AP in some embodiments) to acknowledge that the STA received the data. In an embodiment, while the shared AP transmits a NCJT PPDU to the STA, the sharing AP may transmit a non-NCJT PPDU to another STA that is in a same basic service set (BSS) as the sharing AP. Similarly, while the sharing AP transmits a NCJT PPDU to the STA, the shared AP may transmit a non-NCJT PPDU to another STA that is in a same BSS as the shared AP.

According to some embodiments (embodiments where the sharing AP does not participate in the NCJT), a sharing AP transmits a backhaul data PPDU that includes data intended for a STA to multiple shared AP via respective backhaul links. The sharing AP may then transmit a NCJT sounding trigger frame to the shared APs via the respective backhaul links to cause the shared APs to participate in the NCJT. Responsive to receiving the NCJT sounding trigger frame from the sharing AP, the shared APs may participate in the NCJT by transmitting NCJT PPDUs that include the data intended for the STA to the STA, but at different times. Responsive to receiving the NCJT PPDUs from the shared APs (at different times), the STA may transmit a NCJT ACK frame to one or more of the shared APs to acknowledge that the STA received the data. In an embodiment, while one of the shared APs transmits a NCJT PPDU to the STA, the sharing AP and/or the other shared APs may transmit a non-NCJT PPDU to another STA that is in a same BSS as themselves.

For the proper and efficient functioning of NCJT, the shared APs may need to determine the order of transmitting NCJT PPDUs, the modulation coding scheme (MCS) to use for transmitting the NCJT PPDUs, and/or the lengths of the NCJT PPDUs. Various ways for making such determinations are described herein.

For purposes of illustration, various embodiments are described herein in the context of wireless networks that are based on IEEE 802.11 wireless networking standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

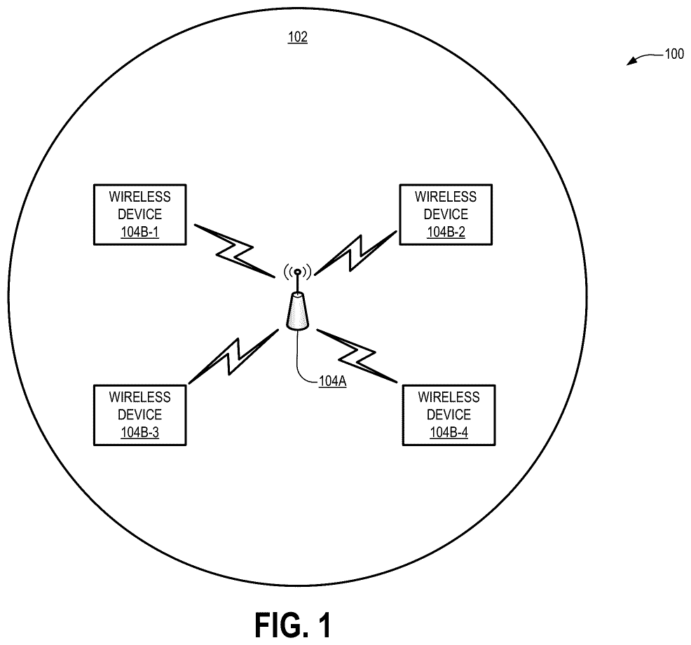

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

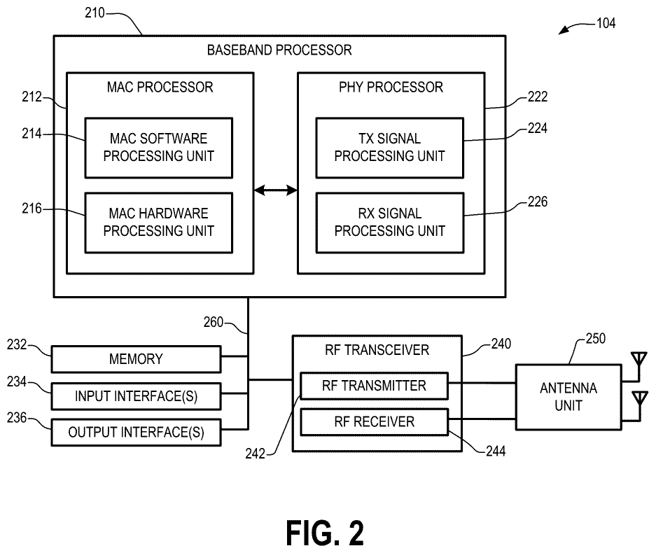

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

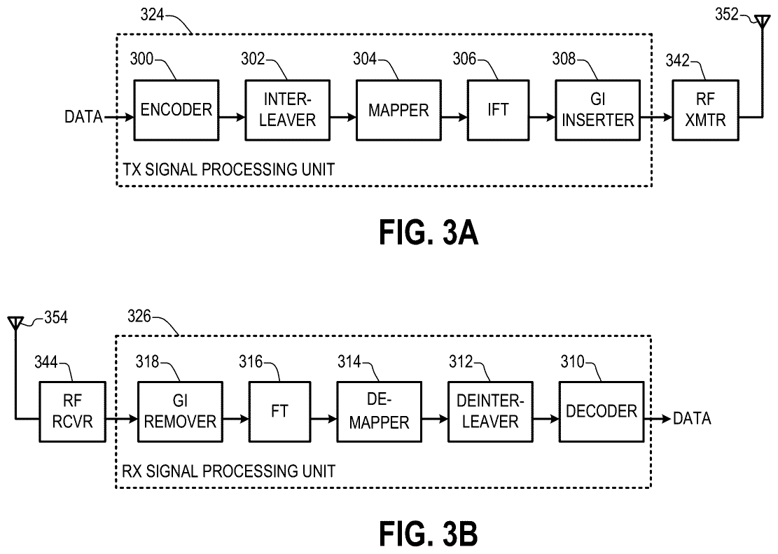

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0 s or 1 s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

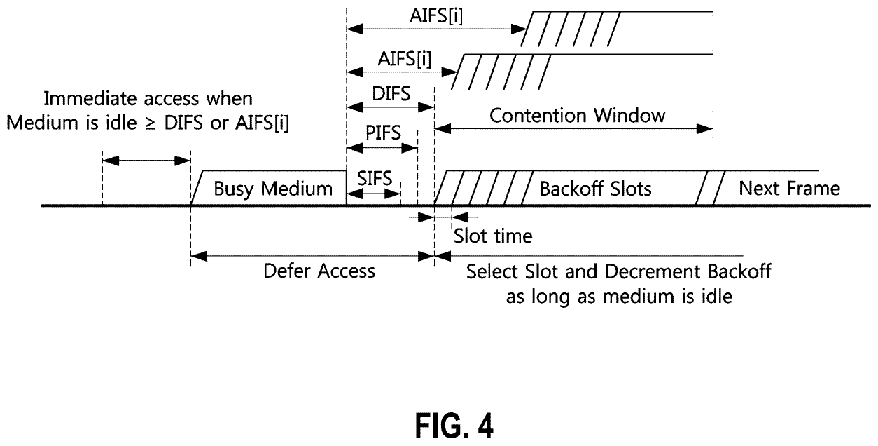

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS [i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS [AC]) has elapsed. When transmitted by the QOS STA, any of the data frame, the management frame, and the control frame, which is not the response frame, may use the AIFS [AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

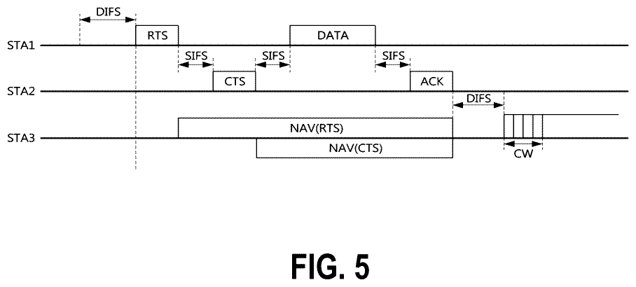

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

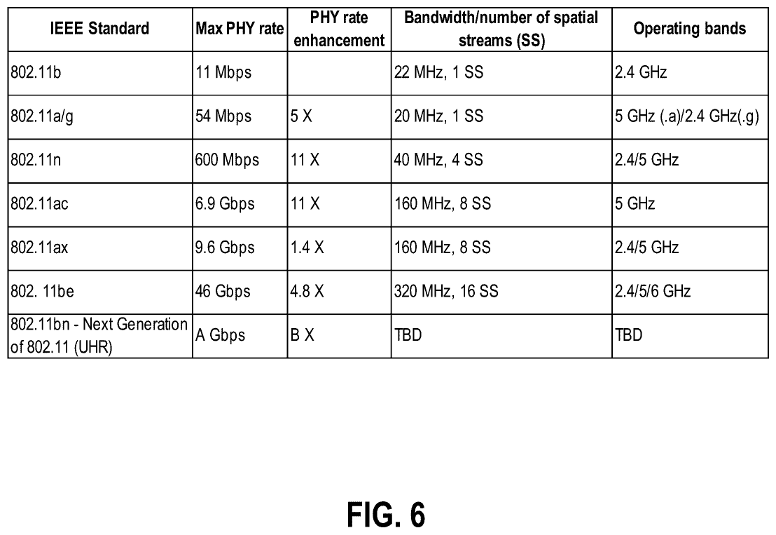

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

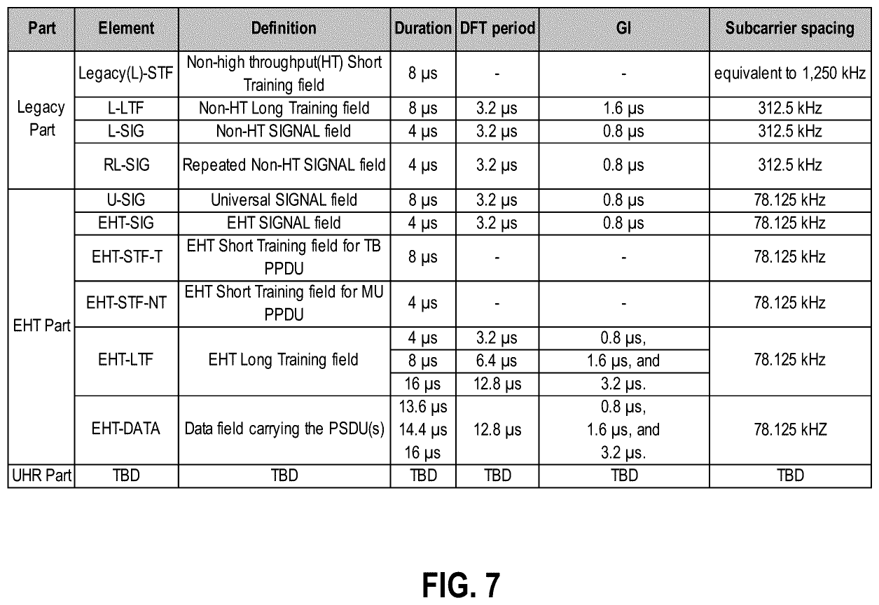

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

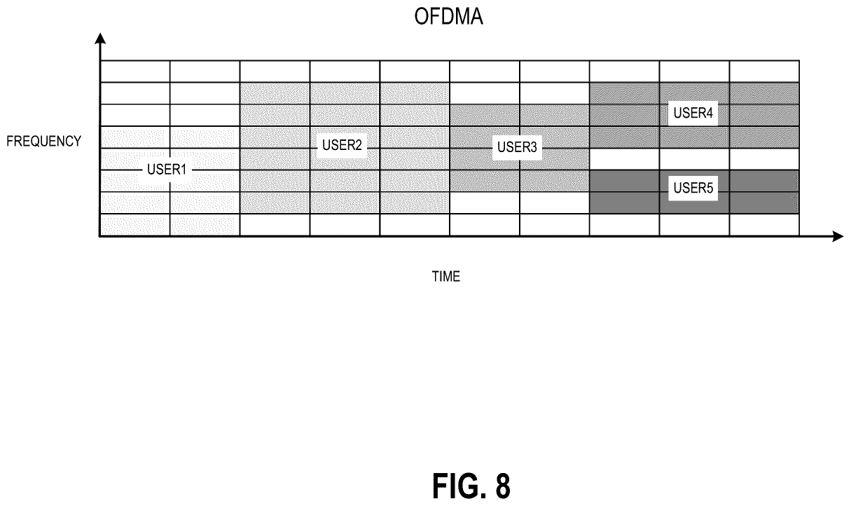

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

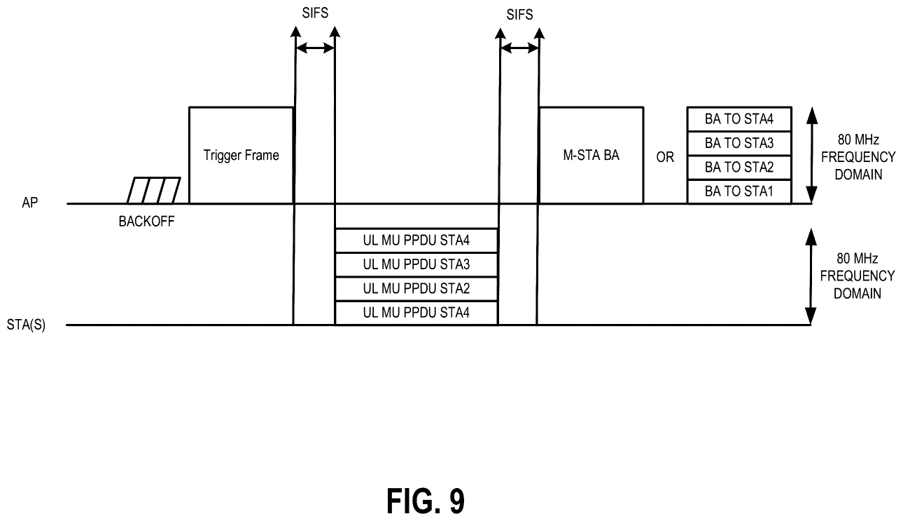

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block

Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Multi-access point (M-AP) coordination is an important candidate feature to be included in future wireless networks (e.g., wireless networks that are to implement the beyond IEEE 802.11be or IEEE 802.11bn wireless networking standard). M-AP coordination technology may not only help improve spectral efficiency but may also reduce the delay (or latency) of data transmissions. Various M-AP coordination schemes have been discussed. For example, with a coordinated beamforming/nulling scheme, multiple APs may share channel state information (CSI) with each other to determine the beamforming/nulling to use in order to transmit data in a manner that minimizes the interference between the APs. With a joint transmission (JTX) scheme, multiple APs may transmit the same data to a STA at the same time (e.g., so that the multiple APs can be considered as a single virtual AP). However, a drawback of a joint transmission scheme is that it requires tight synchronization between APs, which may not always be possible. If the APs are not tightly synchronized with respect to frequency (e.g., carrier frequency offset (CFO)) and timing, the STA may not be able to properly decode the data that was jointly transmitted by the APs. With a joint transmission scheme, to support single user (SU) and/or multi user (MU) multiple input multiple output (MIMO) using one giant precoder over the combined array consisting of the antennas of all APs, the APs may exchange CSI (e.g., precoding matrix) with each other via a backhaul link. Also, the sharing AP may share control information for the joint transmission with a shared AP. If the backhaul link is non-idle (it is busy), some of information (e.g., CSI and/or control information) may be partially (i.e., not fully) transmitted or dropped. In such case, the multiple APs may not be fully synchronized and thus the performance of the joint transmission cannot be guaranteed.

A NCJT scheme is described herein where multiple APs may transmit the same data to a single STA at different times to allow the STA to more reliably decode the data (e.g., even under unfavorable network conditions). The NCJT scheme may allow the STA to more reliably decode the data compared to a joint transmission scheme when the APs are not able to be tightly synchronized (e.g., due to the backhaul link between the APs being non-idle/busy).

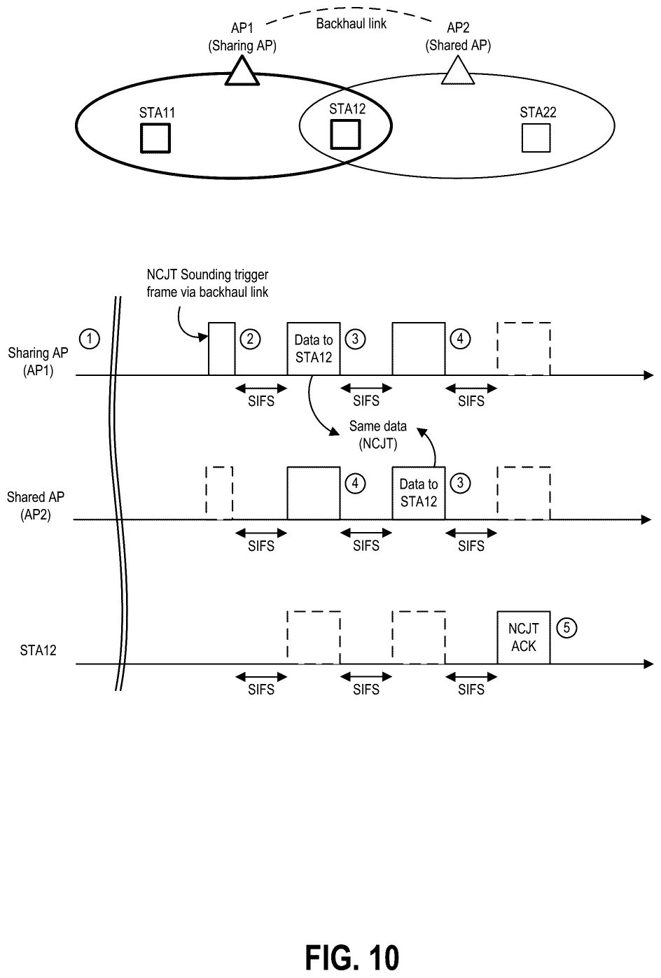

FIG. 10 is a diagram showing a frame exchange sequence of a NCJT scheme in which a sharing AP participates in the NCJT, according to some embodiments. In the example shown in the diagram, the NCJT scheme may involve a first AP (AP1) operating as a sharing AP and a second AP (AP2) operating as a shared AP. AP1 and AP2 may communicate via a backhaul link. AP1 may operate a first BSS that includes STAs STA11 and STA12. AP2 may operate a second BSS that includes STA STA22. In this example, STA12 may be in the coverage areas of both AP1 and AP2, and thus may be a candidate for a NCJT. While a particular network configuration is shown in the diagram for purposes of illustrating the principles of a NCJT scheme, it should be appreciated that the NCJT scheme described herein can be implemented in a wireless network having a different network configuration than what is shown in the diagram. For example, while the diagram shows an example where there is only one shared AP (AP2), those skilled in the art will appreciate that the NCJT scheme described herein can be extended to apply to a situation where there is more than one shared AP. Thus, the network configuration shown in the diagram should be considered as being illustrative rather than restrictive.

At operation 1 shown in the diagram, AP1 may transmit a backhaul data PPDU that includes data intended for STA12 to AP2 via the backhaul link. A backhaul data PPDU may be a PPDU that includes data intended for a STA and that is transmitted by an AP to another AP via a backhaul link.

At operation 2 shown in the diagram, AP1 may transmit a NCJT sounding trigger frame to AP2 via the backhaul link to cause the AP2 to participate in a NCJT to STA12. The NCJT sounding trigger frame may include various control information regarding the NCJT.

In an embodiment, the NCJT sounding trigger frame indicates the ACK scheme that is to be used by STA12 for acknowledging that it received the data that was transmitted as part of the NCJT (e.g., the acknowledgment may occur at operation 5 shown in the diagram).

In an embodiment, the NCJT sounding trigger frame indicates the length of the NCJT PPDUs that are to be transmitted as part of the NCJT (e.g., the NCJT PPDUs transmitted at operation 3 shown in the diagram).

At operation 3 shown in the diagram, following a short interframe space (SIFS) interval after transmitting the NCJT sounding trigger frame, AP1 may transmit a NCJT PPDU that includes the data intended for STA12 to STA12. Also, responsive to receiving the NCJT sounding trigger frame from AP1, AP2 may transmit a NCJT PPDU that includes the data intended for STA12 to STA12 following a SIFS interval after AP1 finishes transmitting its NCJT PPDU. Thus, AP1 and AP2 may each transmit a NCJT PPDU that includes the data intended for STA12 to STA12, but at different times. In this example, AP1 transmits its NCJT PPDU following a SIFS interval after the end of the transmission of the NCJT sounding trigger frame, and AP2 transmits its NCJT PPDU following two SIFS intervals and the length of API's NCJT PPDU after the end of the transmission of the NCJT sounding trigger frame. AP1 and AP2′s transmission of NCJT PPDUs may form a NCJT. A NCJT PPDU may be a PPDU that is transmitted as part of a NCJT.

At operation 4 shown in the diagram, while AP1 transmits its NCJT PPDU to STA12, AP2 may transmit a non-NCJT PPDU to another STA in the same BSS as AP2. For example, AP2 may transmit a non-NCJT PPDU to STA22. Similarly, while AP2 transmits its NCJT PPDU to STA12, AP1 may transmit a non-NCJT PPDU to another STA in the same BSS as AP1. For example, AP1 may transmit a non-NCJT PPDU to STA11. A non-NCJT PPDU may be a PPDU that is not transmitted as part of a NCJT.

At operation 5 shown in the diagram, responsive to receiving the NCJT PPDUs from AP1 and AP2, STA12 may transmit a NCJT ACK frame to acknowledge that it received the data included in the NCJT PPDUs. In an embodiment, STA12 transmits a NCJT ACK frame to both AP1 and AP2 simultaneously. In an embodiment, STA12 transmits a NCJT ACK frame to AP1 and AP1 may transmit a NCJT ACK frame to AP2 in response to receiving the NCJT ACK frame from STA12 (AP1 shares the acknowledgement it received from STA12 with AP2). In an embodiment, STA12 transmits a NCJT ACK frame to AP1 and AP1 does not share the acknowledgement from STA12 with AP2. Thus, various acknowledgment schemes are possible. In an embodiment, as previously mentioned, the NCJT sounding trigger frame indicates the acknowledgement scheme that is to be used by STA12 for acknowledging that it received the data that was transmitted as part of the NCJT (e.g., the data transmitted by AP1 and AP2).

While an example is shown in the diagram in which AP1 (the sharing AP) transmits its NCJT PPDU before AP2 transmits its NCJT PPDU, in some embodiments the order of NCJT PPDU transmission may be reversed.

For the proper and efficient functioning of a NCJT, AP1 and AP2 may need to determine the MCS to use for transmitting their respective NCJT PPDUs. Various ways to determine the MCS are described below. The way to determine the MCS may be categorized based on (1) whether the MCSs that are used for transmitting the NCJT PPDUs are the same or can be different; and (2) whether the NCJT sounding trigger frame indicates a MCS value or not.

The MCSs that are used for transmitting the NCJT PPDUs are the same and the NCJT sounding trigger frame does not indicate a MCS value

If the channel quality of the backhaul link (between AP1 and AP2) is worse than the channel quality of the link between AP1 and STA12, then NCJT is not performed. Otherwise, if the channel quality of the backhaul link is equal or better than the channel quality of the link between AP1 and STA12, then AP1 may transmit its NCJT PPDU to STA12 using a MCS that is determined based on the channel quality of the link between AP1 and STA12. AP1 may transmit the backhaul data PPDU to AP2 using the same MCS (e.g., at operation 1 shown in FIG. 10). AP2 may transmit its NCJT PPDU to STA12 using the same MCS that AP1 used for transmitting the backhaul data PPDU to AP2 (e.g., the backhaul data PPDU that AP1 transmitted to AP2 at operation 1 shown in FIG. 10). Since the MCSs used by AP1 and AP2 for transmitting their NCJT PPDUs are the same, STA12 may decode the NCJT PPDUs using a soft combining technique or similar technique. A soft combining technique is a technique where the receiver (e.g., a STA) combines previously received data (e.g., soft bits) with a received repetition of the data to obtain the originally transmitted data.

The MCSs that are used for transmitting the NCJT PPDUs are the same and the NCJT sounding trigger frame indicates a MCS value

The MCS value indicated in the NCJT sounding trigger frame may be determined based on the channel quality of the link between AP1 and STA12. AP1 may transmit its NCJT PPDU to STA12 using a MCS corresponding to this MCS value. Also, AP2 may transmit its NCJT PPDU to STA12 using a MCS corresponding to the MCS value indicated in the NCJT sounding trigger frame. Since the MCSs used by AP1 and AP2 for transmitting their NCJT PPDUs are the same, STA12 may decode the NCJT PPDUs using a soft combining technique or similar technique.

The MCSs that are used for transmitting the NCJT PPDUs can be different and the NCJT sounding trigger frame does not indicate a MCS value

AP1 may transmit a backhaul data PPDU that includes data intended for STA12 to AP2 using a MCS that is determined based on the channel quality of the backhaul link between AP1 and AP2 or a MCS that is determined based on the channel quality of the link between AP1 and STA12. AP1 may transmit its NCJT PPDU to STA12 using a MCS that is determined based on the channel quality of the link between AP1 and STA12. AP2 may determine the MCS to use on its own. In an embodiment, AP2 may transmit its NCJT PPDU using a MCS that is determined based on the channel quality of the link between AP2 and STA12. In another embodiment, AP2 may transmit its NCJT PPDU using the same MCS that AP1 used for transmitting the backhaul data PPDU to AP2. STA12 may decode the NCJT PPDUs differently depending on whether the MCSs used for transmitting the NCJT PPDUs are the same or different. If the MCSs used for transmitting the NCJT PPDUs are the same, then STA12 may decode the NCJT PPDUs using a soft combining technique or similar technique. Otherwise, if the MCSs used for transmitting the NCJT PPDUs are different, then STA12 may decode the NCJT PPDUs using an AP selection technique or similar technique. An AP selection technique is a technique where the receiver (e.g., a STA) may select a successfully decoded PPDU received from one of the APs.

The MCSs that are used for transmitting the NCJT PPDUs can be different and the NCJT sounding trigger frame indicates a MCS value

AP2 may inform AP1 regarding the channel quality of the link between AP2 and STA12. The MCS value indicated in the NCJT sounding trigger frame may be determined based on the channel quality of the link between AP2 and STA12. In an embodiment, AP1 transmits its NCJT PPDU to STA12 using a MCS that is determined based on the channel quality of the link between AP2 and STA12, and AP2 transmits its NCJT PPDU to STA12 using a MCS that corresponds to the MCS value indicated in the NCJT sounding trigger frame. In another embodiment, AP1 transmits its NCJT PPDU to STA12 using a MCS that is determined based on the channel quality of the link between AP1 and STA12 (even though AP1 knows the channel quality of the link between AP2 and STA12), and AP2 transmits its NCJT PPDU to STA12 using a MCS that corresponds to the MCS value indicated in the NCJT sounding trigger frame. STA12 may decode the NCJT PPDUs differently depending on whether the MCSs used for transmitting the NCJT PPDUs are the same or different. If the MCSs used for transmitting the NCJT PPDUs are the same, then STA12 may decode the NCJT PPDUs using a soft combining technique or similar technique. Otherwise, if the MCSs used for transmitting the NCJT PPDUs are different, then STA12 may decode the NCJT PPDUs using an AP selection technique or similar technique.

With a joint transmission and a NCJT scheme, one AP may be the main AP that can be heard by other APs and is responsible for coordinating/initiating the joint transmission or NCJT with the other APs. The main AP may be considered as being a sharing AP and the other APs may be considered as being shared APs. Two coordination scenarios can be considered in this context.

Scenario A: The sharing AP shares control information, CSI, and/or data with the shared APs, and the shared APs perform the joint transmission or NCJT. The sharing AP does not perform the joint transmission or NCJT.

Scenario B: The sharing AP shares control information, CSI, and/or data with the shared APs, and the sharing AP and the shared APs perform the joint transmission or NCJT. That is, the sharing AP also performs the joint transmission or NCJT along with the shared APs. The frame exchange sequence shown in FIG. 10 is an example of a frame exchange sequence under Scenario B.

With a NCJT scheme, a STA who receives PPDUs as part of a NCJT (receives NCJT PPDUs) may decode the PPDUs using a soft combining technique or an AP selection technique depending on whether the MCSs used for transmitting the PPDUs are the same or different. For example, if the MCSs used for transmitting the PPDUs are the same, the STA may decode the PPDUs using a soft combining technique. Otherwise, if the MCSs used for transmitting the PPDUs are different, the STA may decode the PPDUs using an AP selection technique.

Under Scenario B, when NCJT is performed (e.g., PPDUs are transmitted in a time-domain multiplexing (TDM) manner), the sharing AP may transmit a backhaul data PPDU that includes data intended for a STA to a shared AP. The sharing AP may then transmit a NCJT PPDU that includes the data intended for the STA to the STA. Subsequently, the shared AP may transmit a NCJT PPDU that includes the data intended for the STA to the STA. The NCJT sounding trigger frame may indicate the MCS value of the MCS that the shared AP should use for transmitting its NCJT PPDU to the STA. In an embodiment, if the NCJT sounding trigger frame does not indicate a MCS value, the shared AP may use the same MCS that was used by the sharing AP for transmitting the backhaul data PPDU to transmit the shared AP's NCJT PPDU to the STA. In an embodiment, regardless of the MCS indication from the sharing AP, the shared AP may transmit its NCJT PPDU to the STA using a MCS that is determined based on the channel quality of the link between the shared AP and the STA. In an embodiment, if the NCJT sounding trigger frame does not indicate a MCS value, the shared AP does not perform NCJT.

Under Scenario A, when NCJT is performed (e.g., PPDUs are transmitted in a TDM manner), one or more of the following issues may arise.

Issue #1: Under scenario A, the sharing AP that transmits the NCJT sounding trigger frame does not transmit a NCJT PPDU so the mechanism of indicating which MCS to use and/or determining which MCS to use for transmitting NCJT PPDUSs may be different from the mechanism under Scenario B.

Issue #2: There is ambiguity of when shared APs can transmit their NCJT PPDU after receiving the NCJT sounding trigger frame from the sharing AP. Due to the ambiguity, two shared APs that receive the NCJT sounding trigger frame may end up transmitting their NCJT PPDUs at the same time, which can result in a failure of the NCJT.

Issue #3: If a shared AP can determine the MCS to use for transmitting its NCJT PPDU based on the channel quality of the link between the shared AP and the STA regardless of the MCS indication from the sharing AP (similar to the MCS determination mechanism described above for Scenario B), there is ambiguity of when the other shared AP can transmit NCJT PPDU (e.g., because if the next shared AP does not know the MCS that the first AP used for transmitting the NCJT PPDU, the next shared AP may not be able to determine the duration of the NCJT PPDU (the duration of a NCJT PPDU is a function of its length and MCS), and thus not be able to determine the correct timing for transmitting its own NCJT PPDU).

Various ways to address the above-mentioned issues that arise under Scenario A are described herein.

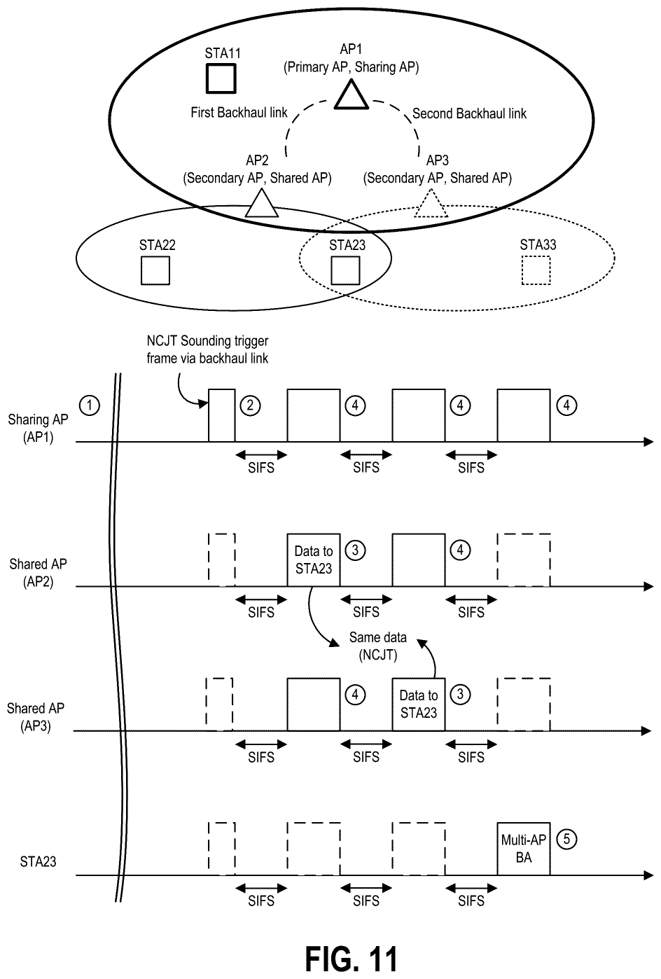

FIG. 11 is a diagram showing a frame exchange sequence of a NCJT scheme in which a sharing AP does not participate in the NCJT, according to some embodiments. In the example shown in the diagram, the NCJT scheme may involve a primary AP (AP1) operating as a sharing AP, a secondary AP (AP2) operating as a shared AP, and another secondary AP (AP3) operating as another shared AP. AP1 and AP2 may communicate via a first backhaul link. Also, AP1 and AP3 may communicate via a second backhaul link. AP1 may operate a first BSS that includes STA STA11. AP2 may operate a second BSS that includes STAs STA22 and STA23. AP3 may operate a third BSS that includes STA STA33. In this example, STA23 may be in the coverage areas of AP2 and AP3, and thus may be a candidate for a NCJT. For sake of simplicity, the example network configuration shown in the diagram includes one sharing AP and two shared APs. It should be appreciated that the NCJT scheme disclosed herein can be extended to apply to a network configuration that includes more than two shared APs. Also, while a particular network configuration is shown in the diagram for purposes of illustrating the principles of a NCJT scheme, it should be appreciated that the NCJT scheme described herein can be implemented in a wireless network having a different network configuration than what is shown in the diagram. Thus, the network configuration shown in the diagram should be considered as being illustrative rather than restrictive.

At operation 1 shown in the diagram, AP1 may transmit a backhaul data PPDU that includes data intended for STA23 to AP2 via the first backhaul link (between AP1 and AP2). AP1 may also transmit a backhaul data PPDU that includes the same data (intended for STA23) to AP3 via the second backhaul link (between AP1 and AP3).

At operation 2 shown in the diagram, AP1 may transmit a NCJT sounding trigger frame to AP2 and AP3 via the first backhaul link and the second backhaul link, respectively, to cause AP2 and AP3 to participate in a NCJT to STA23. The NCJT sounding trigger frame may include various control information regarding the NCJT.

In an embodiment, the NCJT sounding trigger frame indicates the ACK scheme that is to be used by STA23 for acknowledging that it received the data that was transmitted as part of the NCJT (e.g., the acknowledgment may occur at operation 5 shown in the diagram).

In an embodiment, the NCJT sounding trigger frame indicates the length of the l-th NJCT PPDU (l=1, . . . , L), where L is the number of shared APs.

In an embodiment, the NCJT sounding trigger frame indicates the basic service set identifiers (BSSIDs) of the L shared APs that are to participate in the NCJT (L=2 in this example).

In an embodiment, the NCJT sounding trigger frame indicates the order of NCJT for the shared APs (e.g., AP2 is to transmit first and then AP3 is to transmit second). The order may be specified as an ordered list of BBSIDs.

At operation 3 shown in the diagram, responsive to receiving the NCJT sounding trigger frame from AP1 and following a SIFS interval after AP1 finishes transmitting the NCJT sounding trigger frame, AP2 may transmit a NCJT PPDU that includes the data intended for STA23 to STA23. Also, responsive to receiving the NCJT sounding trigger frame from AP1 and following a SIFS interval after AP2 finishes transmitting its NCJT PPDU to STA23, AP3 may transmit a NCJT PPDU that includes the data intended for STA23 to STA23. Thus, AP2 and AP3 may each transmit a NCJT PPDU that includes the data intended for STA23 to STA23, but at different times. AP2 and AP3′s transmission of NCJT PPDUs may form a NCJT.

At operation 4 shown in the diagram, while AP2 transmits its NCJT PPDU to STA23, AP1 and/or AP3 may transmit a non-NCJT PPDU to another STA in the same BSS. For example, AP1 may transmit a non-NCJT PPDU to STA11 and/or AP3 may transmit a non-NCJT PPDU to STA33. Similarly, while AP3 transmits its NCJT PPDU to STA23, AP1 and/or AP2 may transmit a non-NCJT PPDU to another STA in the same BSS. For example, AP1 may transmit a non-NCJT PPDU to STA11 and/or AP2 may transmit a non-NCJT PPDU to STA22. In an embodiment, AP1 may transmit a non-NCJT PPDU to another STA in the same BSS while STA23 transmits a NCJT ACK frame (e.g., while STA23 transmits a NCJT ACK frame to AP2 and/or to AP3 at operation 5 shown in the diagram).

At operation 5 shown in the diagram, responsive to receiving the NCJT PPDUs from AP2 and AP3, STA23 may transmit a NCJT ACK frame to acknowledge that it received the data included in the NCJT PPDUs. In an embodiment, STA23 transmits a NCJT ACK frame to both AP2 and AP3 simultaneously. Thus, as shown in the diagram, the NCJT ACK frame may be a multi-AP block ACK frame. In an embodiment, STA23 transmits a NCJT ACK frame to AP2 and AP2 may transmit a NCJT ACK frame to AP3 in response to receiving the NCJT ACK frame from STA23 (AP2 shares the acknowledgement it received from STA23 with AP3). In an embodiment, STA23 transmits a NCJT ACK frame to AP3 and AP3 may transmit a NCJT ACK frame to AP2 in response to receiving the NCJT ACK frame from STA23 (AP3 shares the acknowledgement it received from STA23 with AP2). In an embodiment, STA23 transmits a NCJT ACK frame to AP2 and AP2 does not share the acknowledgement from STA23 with AP3. In an embodiment, STA23 transmits a NCJT ACK frame to AP3 and AP3 does not share the acknowledgement from STA23 with AP22. Thus, various acknowledgment schemes are possible. In an embodiment, as previously mentioned, the NCJT sounding trigger frame indicates the acknowledgement scheme that is to be used by STA12 for acknowledging that it received the data that was transmitted as part of the NCJT (e.g., the data transmitted by AP2 and AP3).

For the proper and efficient functioning of a NCJT, AP2 and AP3 may need to determine the order of the NCJT (the order in which AP2 and AP3 transmit their respective NCJT PPDUs). Various ways to determine the order of NCJT are described below.

In an embodiment, the NCJT sounding trigger frame explicitly indicates the order of NCJT for the shared APs. For example, the indicated I can be associated with one of BSSID of shared AP (e.g., the NCJT sounding trigger frame may include a mapping between l and BSSID to indicate that the l-th NCJT PPDU is to be transmitted by the shared AP having the specified BSSID).

In an embodiment, the NCJT sounding trigger frame implicitly indicates the order of NCJT for the shared APs. For example, the NCJT sounding trigger frame may indicate the BSSIDs of the shared APs and the shared APs may understand that the shared AP that has the l-th lowest (or highest) BSSID is to transmit the l-th NCJT PPDU. As another example, the NCJT sounding trigger frame may include L (sub) fields each specifying the BSSID of one of the shared APs, and the shared AP whose BSSID is specified in the l-th (sub) field among the L (sub) fields, performs the l-th NCJT PPDU transmission. As another example, reference AP can be indicated before the reception of the NCJT sounding trigger frame, and the reference AP always performs the first NCJT PPDU transmission and the other AP performs the second NCJT PPDU transmission (this assumes there are two shared APs but there can be multiple reference APs).

In the example shown in the diagram, AP2 transmits its NCJT PPDU first and then AP3 transmits its NCJT PPDU second. Specifically, AP2 transmits its NCJT PPDU following a SIFS interval after the end of the transmission of the NCJT sounding trigger frame, and AP3 transmits its NCJT PPDU following two SIFS intervals and the length/duration of AP2′s NCJT PPDU after the end of the transmission of the NCJT sounding trigger frame. More generally, APₖ may transmit its NCJT PPDU following a (SIFS interval+ [symbol] [the length/duration of the ( [symbol] −1)-th NCJT PPDU +SIFS interval]) time after the end of the transmission of the NCJT sounding trigger frame, where APₖ transmits (l+1)-th NCJT PPDU and k=l+1≥2.

For the proper and efficient functioning of NCJT, AP2 and AP3 may need to determine the MCS to use for transmitting their respective NCJT PPDUs. Various ways to determine the MCS are described below. The way to determine the MCS may be categorized based on (1) whether the MCSs that are used for transmitting the NCJT PPDUs are the same or can be different; and (2) whether the NCJT sounding trigger frame indicates a MCS value or not.

The MCSs that are used for transmitting the NCJT PPDUs are the same and the NCJT sounding trigger frame does not indicate a MCS value

It is assumed that AP1 knows the channel quality of the link between one of the shared APs (e.g., AP2) and STA23. The other shared AP (e.g., AP3) may or may not know the channel quality of the link between itself and STA23. If the channel quality of the first backhaul link (between AP1 and AP2) and/or the channel quality of the second backhaul link (between AP1 and AP3) is worse than the known channel quality of the link between one of the shared APs and STA23, then NCJT is not performed. Otherwise, if the channel qualities of the first backhaul link and the second backhaul link are equal or better than the known channel quality of the link between one of the shared APs and STA23, then AP1 may transmit the backhaul data PPDU to AP2 and AP3 using a MCS that is determined based on the known channel quality of the link between one of the shared APs and STA23 (e.g., at operation 1 shown in FIG. 11) or transmit the backhaul data PPDU to AP2 and AP3 using a MCS that is determined based on the channel quality of the backhaul link between AP1 and one of the shared APs. AP2 may transmit its NCJT PPDU to STA23 using the same MCS that AP1 used for transmitting the backhaul data PPDU to AP2 (e.g., the backhaul data PPDU that AP1 transmitted to AP2 at operation 1 shown in FIG. 11). Also, AP3 may transmit its NCJT PPDU to STA23 using the same MCS that AP1 used for transmitting the backhaul data PPDU to AP2. Since the MCSs used by AP2 and AP3 for transmitting their NCJT PPDUs are the same, STA23 may decode the NCJT PPDUs using a soft combining technique or similar technique.

The MCSs that are used for transmitting the NCJT PPDUs are the same and the NCJT sounding trigger frame indicates a MCS value

It is assumed that AP1 knows the channel quality of the link between one of the shared APs (e.g., AP2) and STA23. The other shared AP (e.g., AP3) may or may not know the channel quality of the link between itself and STA23. The MCS value indicated in the NCJT sounding trigger frame may be determined based on the known channel quality of the link between one of the shared APs and STA23. AP2 and AP3 may transmit their NCJT PPDUs to STA23 using a MCS corresponding to the MCS value indicated in the NCJT sounding trigger frame. Since the MCSs used by AP2 and AP3 for transmitting their NCJT PPDUs are the same, STA23 may decode the NCJT PPDUs using a soft combining technique or similar technique.

The MCSs that are used for transmitting the NCJT PPDUs can be different and the NCJT sounding trigger frame does not indicate a MCS value

It is assumed that each shared AP (e.g., AP2 and AP3) knows the channel quality of the link between itself and STA23. The shared APs may determine the MCS to use for transmitting their NCJT PPDUs to STA23 on their own. For example, AP2 may transmit its NCJT PPDU to STA23 using a MCS that is determined based on the channel quality of the link between itself and STA23. Also, AP3 may transmit its NCJT PPDU to STA23 using a MCS that is determined based on the channel quality of the link between itself and STA23. STA23 may decode the NCJT PPDUs differently depending on whether the MCSs used for transmitting the NCJT PPDUs are the same or different. If the MCSs used for transmitting the NCJT PPDUs are the same, then STA23 may decode the NCJT PPDUs using a soft combining technique or similar technique. Otherwise, if the MCSs used for transmitting the NCJT PPDUs are different, then STA23 may decode the NCJT PPDUs using an AP selection technique or similar technique.

The MCSs that are used for transmitting the NCJT PPDUs can be different and the NCJT sounding trigger frame indicates a MCS value

It is assumed that each shared AP (e.g., AP2 and AP3) knows the channel quality of the link between itself and STA23. Also, it is assumed that AP1 knows the channel quality of the link between at least one of the shared APs (e.g., AP2) and STA23. The MCS value indicated in the NCJT sounding trigger frame may be determined based on the known channel quality of the link between one of the shared APs and STA23.

In an embodiment, AP2 and AP3 transmit their NCJT PPDUs to STA23 using a MCS that corresponds to the MCS value indicated in the NCJT sounding trigger frame. The lengths of the NCJT PPDUs can be indicated in the NCJT sounding trigger frame.

In an embodiment, each shared AP chooses between a calculated MCS value and the MCS value indicated in the NCJT sounding trigger frame. The calculated MCS value may be determined based on the channel quality of the link between the shared AP and STA23. Each shared AP may then transmit its NCJT PPDU to STA23 using a MCS that corresponds to the chosen MCS value.

In an embodiment, one of the shared APs (e.g., AP3) transmits its NCJT PPDU to STA23 using a MCS that corresponds to the MCS value indicated in the NCJT sounding trigger frame. Another shared AP (e.g., AP3) chooses between a calculated MCS value and the MCS value indicated in the NCJT sounding trigger frame, and transmits its NCJT PPDU to STA23 using a MCS that corresponds to the chosen MCS value. The calculated MCS value may be determined based on the channel quality of the link between the shared AP (e.g., AP3) and STA23. The length of the first NCJT PPDU to be transmitted can be indicated in the NCJT sounding trigger frame.

STA23 may decode the NCJT PPDUs differently depending on whether the MCSs used for transmitting the NCJT PPDUs are the same or different. If the MCSs used for transmitting the NCJT PPDUs are the same, then STA23 may decode the NCJT PPDUs using a soft combining technique or similar technique. Otherwise, if the MCSs used for transmitting the NCJT PPDUs are different, then STA23 may decode the NCJT PPDUs using an AP selection technique or similar technique.

For the proper and efficient functioning of NCJT, AP2 and AP3 may need to determine the lengths of NCJT PPDUs. Various ways to determine the lengths of NCJT PPDUs are described below.

In an embodiment, the NCJT sounding trigger frame indicates the length of the l-th NJCT PPDU (l=1, . . . , L), where L is the number of shared APs. In an embodiment, the length of the l-th NCJT PPDU of the MCS value in the NCJT sounding trigger frame can be indicated. If a shared AP that transmits the l-th NCJT PPDU uses the MCS value, it also uses the length of the l-th NCJT PPDU (e.g., the NCJT sounding trigger frame may include a mapping between a MCS value and a length, and if AP2 chooses to use the MCS value, AP3 may know that it can transmit its NCJT PPDU after AP2 transmits AP2′s NCJT PPDU). In an embodiment, the length of the l-th NCJT PPDU of candidate MCS values in the NCJT sounding trigger frame can be indicated. If a shared AP that transmits the l-th NCJT PPDU uses one of the candidate MCS values, it also uses the length of the l-th NCJT PPDU associated with the used MCS value. It should be noted that the length determination mechanism described herein can be used under Scenario A and Scenario B mentioned above.

The NCJT scheme described herein allows multiple APs to transmit the same data to the same STA without requiring tight synchronization between the APs with regard to frequency and timing. Thus, when tight synchronization between APs is not possible (e.g., due to a non-idle/busy backhaul link), the NCJT scheme may perform better compared to a joint transmission scheme. The NCJT scheme may allow a STA that is within the coverage areas of the APs to more reliably decode the data transmitted by the APs.

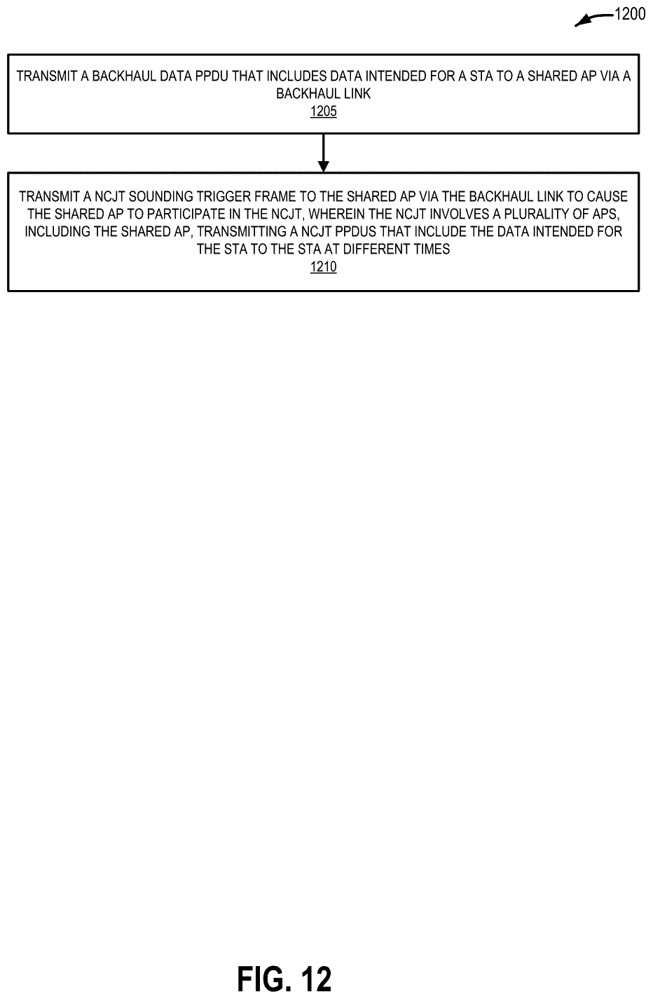

Turning now to FIG. 12, a method 1200 will be described for initiating a NCJT, in accordance with an example embodiment. The method 1200 may be performed by a sharing AP. The sharing AP may be implemented by a wireless device (e.g., wireless device 104).

Additionally, although shown in a particular order, in some embodiments the operations of the method 1200 (and the other methods shown in the other figures) may be performed in a different order. For example, although the operations of the method 1200 are shown in a sequential order, some of the operations may be performed in partially or entirely overlapping time periods.

At operation 1205, the sharing AP transmits a backhaul data PPDU that includes data intended for a STA to a shared AP via a backhaul link.

At operation 1210, the sharing AP transmits a NCJT sounding trigger frame to the shared AP via the backhaul link to cause the shared AP to participate in the NCJT, wherein the NCJT involves a plurality of APs, including the shared AP, transmitting NCJT PPDUs that include the data intended for the STA to the STA at different times.

In an embodiment, the sharing AP transmits a NCJT PPDU that includes the data intended for the STA to the STA (e.g., if the sharing AP also participates in the NCJT). In an embodiment, the sharing AP determines a MCS value based on a channel quality of a link between the sharing AP and the STA. In an embodiment, the NCJT sounding trigger frame does not indicate the MCS value, wherein the backhaul data PPDU and the NCJT PPDU are transmitted using a MCS corresponding to the MCS value that was determined based on the channel quality of the link between the sharing AP and the STA. In an embodiment, the sharing AP determines a backhaul MCS value based on a channel quality of the backhaul link, wherein the NCJT sounding trigger frame does not indicate the MCS value, wherein the backhaul data PPDU is transmitted using a MCS corresponding to the backhaul MCS value and the NCJT PPDU is transmitted using a MCS corresponding to the MCS value that was determined based on the channel quality of the link between the sharing AP and the STA. In an embodiment, the NCJT sounding trigger frame indicates the MCS value that was determined based on the channel quality of the link between the sharing AP and the STA, wherein the NCJT PPDU is transmitted using a MCS corresponding to the MCS value. In an embodiment, the sharing AP determines a first MCS value based on a channel quality of a first link between the shared AP and the STA, wherein the NCJT sounding trigger frame indicates the first MCS value. In an embodiment, the NCJT PPDU is transmitted using a first MCS corresponding to the first MCS value. In an embodiment, the sharing AP determines a second MCS value based on a channel quality of a second link between the sharing AP and the STA, wherein the NCJT PPDU is transmitted using a second MCS corresponding to the second MCS value.

In an embodiment, the sharing AP receives a NCJT ACK frame from the STA that acknowledges that the STA received the data intended for the STA. In an embodiment, responsive to receiving the NCJT ACK frame, the sharing AP transmits a NCJT ACK frame to the shared AP. In an embodiment, while the shared AP transmits a NCJT PPDU to the STA, the sharing AP transmits a non-NCJT PPDU to a different STA that is in a same BSS as the sharing AP.

In an embodiment, the plurality of APs further includes a second shared AP in addition to the first-mentioned shared AP, wherein the backhaul data PPDU and the NCJT sounding trigger frame are also transmitted to the second shared AP via a second backhaul link. In an embodiment, the sharing AP determines a backhaul MCS value based on a channel quality of a link between the sharing AP and the first-mentioned shared AP, wherein the NCJT sounding trigger frame does not indicate the MCS value, wherein the backhaul data PPDU is transmitted to the first-mentioned shared AP and the second shared AP using a MCS corresponding to the backhaul MCS value. In an embodiment, the sharing AP determines a MCS value based on a channel quality of a link between the first-mentioned shared AP and the STA, wherein the NCJT sounding trigger frame indicates the MCS value.

In an embodiment, while the first-mentioned shared AP or the second shared AP transmits a NCJT PPDU to the STA, the sharing AP transmits a non-NCJT PPDU to a different STA that is in a same BSS as the sharing AP.

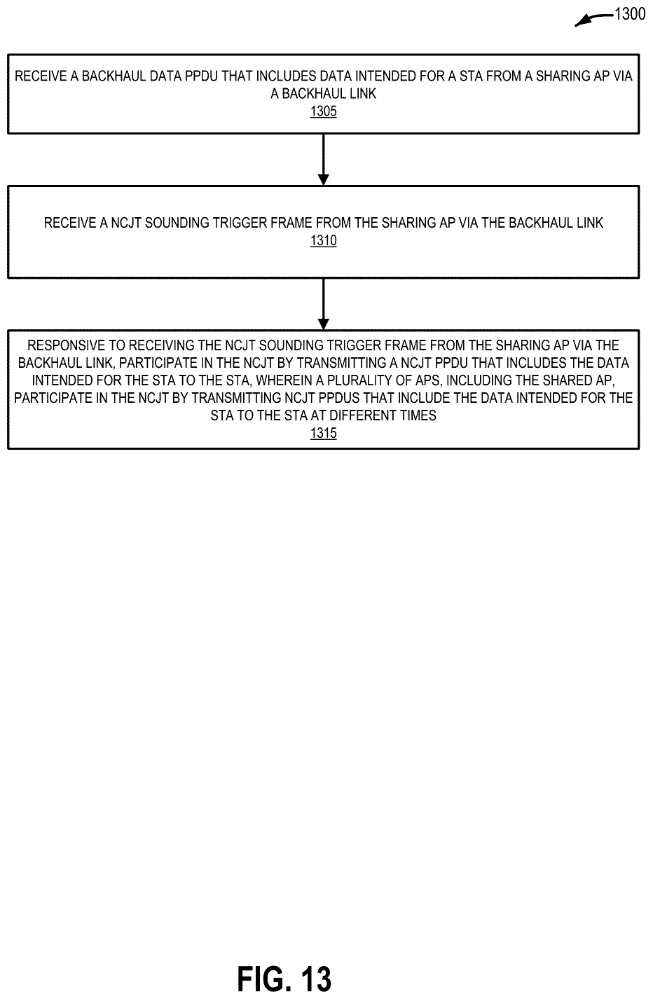

Turning now to FIG. 13, a method 1300 will be described for participating in a NCJT, in accordance with an example embodiment. The method 1300 may be performed by a shared AP. The shared AP may be implemented by a wireless device (e.g., wireless device 104).

At operation 1305, the shared AP receives a backhaul data PPDU that includes data intended for a STA from a sharing AP via a backhaul link.

At operation 1310, the shared AP receives a NCJT sounding trigger frame from the sharing AP via the backhaul link.

At operation 1315, responsive to receiving the NCJT sounding trigger frame from the sharing AP via the backhaul link, the shared AP participates in the NCJT by transmitting a NCJT PPDU that includes the data intended for the STA to the STA, wherein a plurality of APs, including the shared AP, participate in the NCJT by transmitting NCJT PPDUs that include the data intended for the STA to the STA at different times.

In an embodiment, the shared AP determines a MCS used by the sharing AP to transmit the backhaul data PPDU, wherein the NCJT PPDU is transmitted using the MCS.

In an embodiment, the shared AP obtains a MCS value from the NCJT sounding trigger frame, wherein the NCJT PPDU is transmitted using a MCS corresponding to the MCS value obtained from the NCJT sounding trigger frame.

In an embodiment, the shared AP determines a MCS to use for transmitting the NCJT PPDU based on a channel quality of a link between the shared AP and the STA, wherein the NCJT PPDU is transmitted using the MCS.

In an embodiment, while one of the plurality of APs other than the shared AP transmits a NCJT PPDU to the STA, the shared AP transmits a non-NCJT PPDU to a different STA that is in a same BSS as the shared AP.

In an embodiment, the shared AP receives a NCJT ACK frame from the STA that acknowledges that the STA received the data intended for the STA. In an embodiment, responsive to receiving the NCJT ACK frame, the shared AP transmits a NCJT ACK frame that acknowledges that the STA received the data intended for the STA to one or more of the plurality of APs.

In an embodiment, the shared AP receives a NCJT ACK frame from one of the plurality of APs that acknowledges that the STA received the data intended for the STA.

In an embodiment, the plurality of APs (that participate in the NCJT) includes the sharing AP.

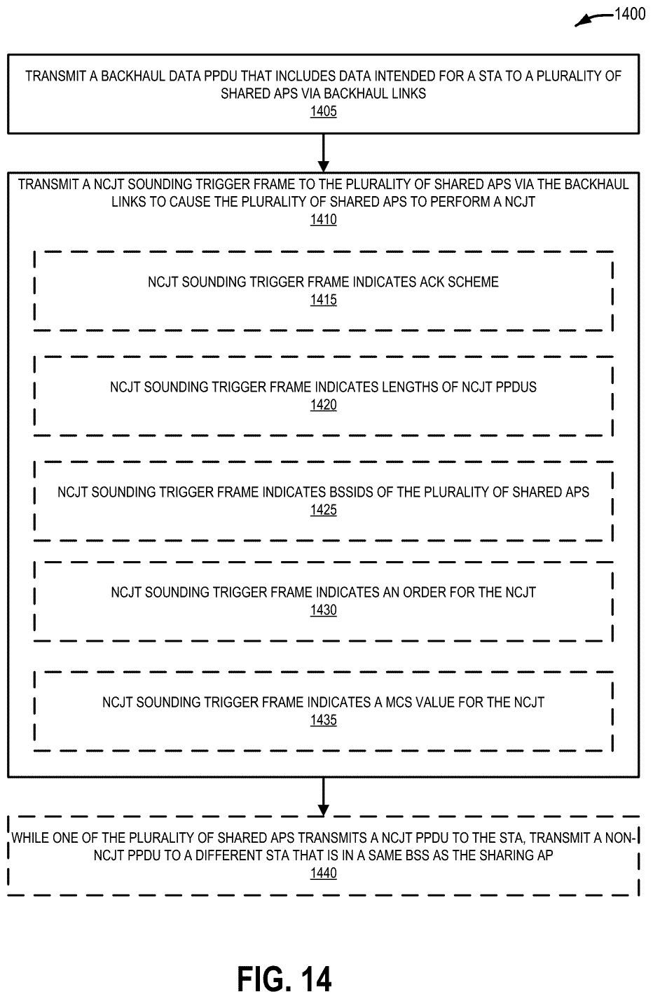

Turning now to FIG. 14, a method 1400 will be described for initiating a NCJT, in accordance with an example embodiment. The method 1400 may be performed by a sharing AP. The sharing AP may be implemented by a wireless device (e.g., wireless device 104).

At operation 1405, the sharing AP transmits a backhaul data PPDU that includes data intended for a STA to a plurality of shared APs via backhaul links.

At operation 1410, the sharing AP transmits a NCJT sounding trigger frame to the plurality of shared APs via the backhaul links to cause the plurality of shared APs to perform a NCJT. In an embodiment, as shown in block 1415, the NCJT sounding trigger frame indicates the ACK scheme (that the STA is to use for acknowledging that it received the data transmitted as part of the NCJT). In an embodiment, as shown in block 1420, the NCJT sounding trigger frame indicates lengths of NCJT PPDUs (that are to be transmitted as part of the NCJT). In an embodiment, as shown in block 1425, the NCJT sounding trigger frame indicates BSSIDs of the plurality of shared APs. In an embodiment, as shown in block 1430, the NCJT sounding trigger frame indicates an order for the NCJT (the order in which the shared APs of the plurality of shared APs are to transmit NCJT PPDUs). In an embodiment, as shown in block 1435, the NCJT sounding trigger frame indicates a MCS value for the NCJT (the MCS value corresponding to the MCS that the shared APs should use for transmitting NCJT PPDUs).

In an embodiment, at operation 1440, while one of the plurality of shared APs transmits a NCJT PPDU to the STA, the sharing AP transmits a non-NCJT PPDU to a different STA that is in a same BSS as the sharing AP.

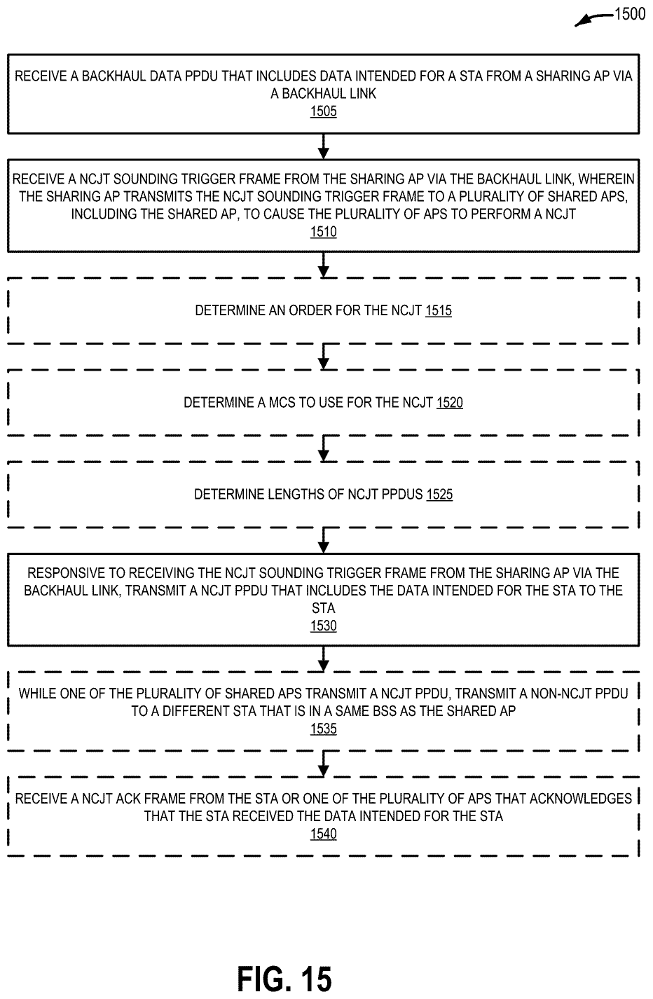

Turning now to FIG. 15, a method 1500 will be described for participating in a NCJT, in accordance with an example embodiment. The method 1500 may be performed by a shared AP. The shared AP may be implemented by a wireless device (e.g., wireless device 104).

At operation 1505, the shared AP receives a backhaul data PPDU that includes data intended for a STA from a sharing AP via a backhaul link.

At operation 1510, the shared AP receives a NCJT sounding trigger frame from the sharing AP via the backhaul link, wherein the sharing AP transmits the NCJT sounding trigger frame to a plurality of shared APs, including the shared AP, to cause the plurality of APs to perform a NCJT.

In an embodiment, at operation 1515, the shared AP determines an order for the NCJT (e.g., based on information included in the NCJT sounding trigger frame).

In an embodiment, at operation 1520, the shared AP determines a MCS to use for the NCJT (e.g., independently or based on information included in the NCJT sounding trigger frame).

In an embodiment, at operation 1525, the shared AP determines lengths of NCJT PPDUs that are to be transmitted as part of the NCJT (e.g., based on information included in the NCJT sounding trigger frame).

At operation 1530, responsive to receiving the NCJT sounding trigger frame from the sharing AP via the backhaul link, the shared AP transmits a NCJT PPDU that includes the data intended for the STA to the STA (e.g., in the order determined at operation 1515 and using the MCS determined at operation 1520—the timing of the NCJT PPDU transmission may be determined based on the lengths of NCJT PPDUs determined at operation 1525).

In an embodiment, at operation 1535, while one of the plurality of shared APs transmits a NCJT PPDU, the shared AP transmits a non-NCJT PPDU to a different STA that is in a same BSS as the shared AP.

In an embodiment, at operation 1540, the shared AP receives a NCJT ACK frame from the STA or one of the plurality of APs that acknowledges that the STA received the data intended for the STA.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a sharing access point (AP) to initiate a non-coherent joint transmission (NCJT), the method comprising:
transmitting a backhaul data PPDU that includes data intended for a station (STA) to a shared AP via a backhaul link; and
transmitting a NCJT sounding trigger frame to the shared AP via the backhaul link to cause the shared AP to participate in the NCJT, wherein the NCJT involves a plurality of APs, including the shared AP, transmitting NCJT PPDUs that include the data intended for the STA to the STA at different times.

2. The method of claim 1, wherein the plurality of APs includes the sharing AP, wherein the method further comprises:
transmitting a NCJT PPDU that includes the data intended for the STA to the STA.

3. The method of claim 2, further comprising:
determining a modulation coding scheme (MCS) value based on a channel quality of a link between the sharing AP and the STA.

4. The method of claim 3, wherein the NCJT sounding trigger frame does not indicate the MCS value, wherein the backhaul data PPDU and the NCJT PPDU are transmitted using a MCS corresponding to the MCS value.

5. The method of claim 3, further comprising:
determining a backhaul MCS value based on a channel quality of the backhaul link, wherein the NCJT sounding trigger frame does not indicate the MCS value, wherein the backhaul data PPDU is transmitted using a MCS corresponding to the backhaul MCS value and the NCJT PPDU is transmitted using a MCS corresponding to the MCS value that was determined based on the channel quality of the link between the sharing AP and the STA.

6. The method of claim 3, wherein the NCJT sounding trigger frame indicates the MCS value, wherein the NCJT PPDU is transmitted using a MCS corresponding to the MCS value.

7. The method of claim 2, further comprising:
determining a first modulation and coding scheme (MCS) value based on a channel quality of a first link between the shared AP and the STA, wherein the NCJT sounding trigger frame indicates the first MCS value.

8. The method of claim 7, wherein the NCJT PPDU is transmitted using a first MCS corresponding to the first MCS value.

9. The method of claim 7, further comprising:
determining a second MCS value based on a channel quality of a second link between the sharing AP and the STA, wherein the NCJT PPDU is transmitted using a second MCS corresponding to the second MCS value.

10. The method of claim 2, further comprising:
receiving a NCJT acknowledgement (ACK) frame from the STA that acknowledges that the STA received the data intended for the STA.

11. The method of claim 10, further comprising:
responsive to receiving the NCJT ACK frame, transmitting a NCJT ACK frame to the shared AP.

12. The method of claim 2, further comprising:
while the shared AP transmits a NCJT PPDU to the STA, transmitting a non-NCJT PPDU to a different STA that is in a same basic service set (BSS) as the sharing AP.

13. The method of claim 1, wherein the plurality of APs further includes a second shared AP in addition to the first-mentioned shared AP, wherein the backhaul data PPDU and the NCJT sounding trigger frame are also transmitted to the second shared AP via a second backhaul link.

14. The method of claim 13, further comprising:
determining a backhaul modulation coding scheme (MCS) value based on a channel quality of a link between the sharing AP and the first-mentioned shared AP, wherein the NCJT sounding trigger frame does not indicate the MCS value, wherein the backhaul data PPDU is transmitted to the first-mentioned shared AP and the second shared AP using a MCS corresponding to the backhaul MCS value.

15. The method of claim 13, further comprising:
determining a modulation coding scheme (MCS) value based on a channel quality of a link between the first-mentioned shared AP and the STA, wherein the NCJT sounding trigger frame indicates the MCS value.

16. The method of claim 13, further comprising:
while the first-mentioned shared AP or the second shared AP transmits a NCJT PPDU to the STA, transmitting a non-NCJT PPDU to a different STA that is in a same basic service set (BSS) as the sharing AP.

17. A method performed by a shared access point (AP) to participate in a non-coherent joint transmission (NCJT), the method comprising:
receiving a backhaul data PPDU that includes data intended for a station (STA) from a sharing AP via a backhaul link;
receiving a NCJT sounding trigger frame from the sharing AP via the backhaul link; and
responsive to receiving the NCJT sounding trigger frame from the sharing AP via the backhaul link, participating in the NCJT by transmitting a NCJT PPDU that includes the data intended for the STA to the STA, wherein a plurality of APs, including the shared AP, participate in the NCJT by transmitting NCJT PPDUs that include the data intended for the STA to the STA at different times.

18. The method of claim 17, further comprising:
determining a modulation coding scheme (MCS) used by the sharing AP to transmit the backhaul data PPDU, wherein the NCJT PPDU is transmitted using the MCS.

19. The method of claim 17, further comprising:
obtaining a modulation coding scheme (MCS) value from the NCJT sounding trigger frame, wherein the NCJT PPDU is transmitted using a MCS corresponding to the MCS value obtained from the NCJT sounding trigger frame.

20. The method of claim 17, further comprising:
determining a modulation coding scheme (MCS) to use for transmitting the NCJT PPDU based on a channel quality of a link between the shared AP and the STA, wherein the NCJT PPDU is transmitted using the MCS.

21. The method of claim 17, further comprising:
while one of the plurality of APs other than the shared AP transmits a NCJT PPDU to the STA, transmitting a non-NCJT PPDU to a different STA that is in a same basic service set (BSS) as the shared AP.

22. The method of claim 17, further comprising:
receiving a NCJT acknowledgment (ACK) frame from the STA that acknowledges that the STA received the data intended for the STA.

23. The method of claim 22, further comprising:
responsive to receiving the NCJT ACK frame, transmitting a NCJT ACK frame that acknowledges that the STA received the data intended for the STA to one or more of the plurality of APs.

24. The method of claim 17, further comprising:
receiving a NCJT acknowledgment (ACK) frame from one of the plurality of APs that acknowledges that the STA received the data intended for the STA.

25. The method of claim 17, wherein the plurality of APs includes the sharing AP.
